(19) United States
(12) Patent Application Publication
(10) Pub. No.: US 2025/0061490 A1
(43) Pub. Date: Feb. 20, 2025

(54) Integrating User Declarations in Ads Personalization

(71) Applicant: Google LLC, Mountain View, CA (US)

(72) Inventors: Elena Erbiceanu-Tener, Los Gatos, CA (US); Tianyi Pan, Cupertino, CA (US); Derek Dunfield, New York, NY (US); Khannan Sundar, Mountain View, CA (US); Benjamin Max Ewing, Seattle, WA (US); Mayank Krishna Kedia, San Francisco, CA (US); Fang Han, Livermore, CA (US); Dhruv Sagar, New York, NY (US)

(21) Appl. No.: 18/561,424

(22) PCT Filed: Mar. 2, 2023
(86) PCT No.: PCT/US2023/014332

§ 371 Date: Nov. 16, 2023

(51) Int. Cl. G06Q 30/0251; G06Q 30/0241

(52) U.S. Cl. CPC G06Q 30/0255; G06Q 30/0277

(57) ABSTRACT

The technology is generally directed to personalizing digital components for users based on a merged preference profile. The merged preference profile may be generated based on declared and inferred preferences of the users. The declared and inferred preferences may be preferences related to brands, topics, types of products, etc. The merged preference profile may be used to personalize the digital components output to the user. For example, when identifying digital components to be selected, at least some of the digital components may be selected based on the merged preference profile of the user. At least a portion of the selected digital components may be digital components with a subject matching the preferences of the user, thereby improving the digital components output to the user.

### BACKGROUND

Digital content, such as advertisements, typically appear on a publisher's website or mobile application, alongside organic search results when a user performs a search or browses content. The advertisements are typically selected based on optimizing engagement of the user in an effort to increase click or conversions, with little to no consideration of the user's advertisement preferences, such as a user's explicit preferences. This results in users being provided with advertisements that do not necessarily align with their preferences.

### BRIEF SUMMARY

The technology is generally directed to improving the digital components output on a publisher's website or mobile application based on a user's merged preference profile. The merged preference profile may be determined based on declared and inferred preferences of the user. Declared and inferred preferences may be preferences related to the subject of content, such as the brand, topic, types of products, etc. The merged preference profile may be used to identify digital components to be selected and provided for output to the user. At least some of the selected digital components may be digital components with a subject matching the preferences of the user, thereby improving the digital components output to the user.

One aspect of the technology is directed to a method comprising receiving, by one or more processors from a publisher, a request for at least one digital component for displaying on a page of a publisher, determining, by the one or more processors, declared preferences of a user, determining, by the one or more processors, inferred preferences of the user, merging, by the one or more processors, the declared and inferred preferences of the users into a merged preference profile, where when there is a conflict between at least one declared preference and at least one inferred preference, selecting, by the one or more processors, the at least one declared preference to be included in the merged preference profile, identifying, by the one or more processors, at least one digital component related to the merged preference profile, and providing for output, by the one or more processors to the publisher, at least one selected digital component.

The method may also include discarding, by the one or more processors, the at least one inferred preference in conflict with the at least one declared preference.

The method may also include reserving, by the one or more processors, display space for one or more selected digital components related to the merged preference profile.

The declared preferences of the user may be related to at least one subject of digital components previously provided for output. The declared preferences may include at least one of pure preference declarations or influenced preference declarations. The inferred preferences may be determined by identifying one or more behaviors with respect to a subject of content previously provided for output or one or more search queries for the subject of the content.

Another aspect of the technology is directed to a computer-readable storage medium storing instructions that when executed by one or more processors, cause the one or more processors to receive, from a publisher, a request for at least one digital component for displaying on a page of a publisher, determine declared preferences of a user, determine inferred preferences of the user, merge the declared and inferred preferences of the users into a merged preference profile, where when there is a conflict between at least one declared preference and at least one inferred preference, select the at least one declared preference to be included in the merged preference profile, identify at least one digital component related to the merged preference profile, and provide for output, to the publisher, at least one selected digital component.

Yet another aspect of the technology is generally directed to a system comprising one or more processors. The one or more processors may be configured to receive, from a publisher, a request for at least one digital component for displaying on a page of a publisher, determine declared preferences of a user, determine inferred preferences of the user, merge the declared and inferred preferences of the users into a merged preference profile, wherein when there is a conflict between at least one declared preference and at least one inferred preference, select the at least one declared preference to be included in the merged preference profile, identify at least one digital component related to the merged preference profile, and provide for output, to the publisher, at least one selected digital component.

### BRIEF DESCRIPTION OF THE DRAWINGS

FIG. 1 is an example screenshot illustrating example content in accordance with aspects of the disclosure.

FIG. 2 is a flow diagram for an example method of generating a merged preference profile in accordance with aspects of the disclosure.

FIG. 3 is an example screenshot illustrating example inputs to declare pure preferences in accordance with aspects of the disclosure.

FIG. 4 is an example screenshot illustrating example inputs to declare pure preferences in accordance with aspects of the disclosure.

FIG. 5 is an example screenshot illustrating example inputs to declare influenced preferences in accordance with aspects of the disclosure.

FIG. 6 is an example screenshot illustrating example content to infer preferences in accordance with aspects of the disclosure.

FIG. 7 is an example flow diagram for an example method of resolving conflicts in accordance with aspects of the disclosure.

FIG. 8 is an example of a merged preference profile in accordance with aspects of the disclosure.

FIG. 9 is an example flow diagram providing advertisements in accordance with aspects of the disclosure.

FIG. 10 is a block diagram of an example system in accordance with aspects of the disclosure.

FIG. 11 is a flow diagram for an example method of selecting digital components in accordance with aspects of the disclosure.

### DETAILED DESCRIPTION

The technology is generally directed to improving digital components for users based on a merged preference profile. Improving the digital components for users may, in some examples, include personalizing the digital components for the users. The merged preference profile may be generated based on declared and inferred preferences of the users. The declared and inferred preferences may be preferences related to brands, topics, types of products, etc. The merged preference profile may be used to personalize the digital components output to the user. For example, when selecting digital components, there may be a plurality of digital components to choose from. At least some of the digital components may be selected based on the merged preference profile of the user. The selected digital components may match the preferences of the user. At least a portion of the selected digital components may be digital components with a subject matching the preferences of the user, thereby personalizing the digital components output to the user.

Declared preferences may be preferences that have been chosen by the user, determined based on user responses to survey questions, or determined based on a user's light engagement with content, such as a user's reaction to the content, e.g., “liking”, sharing, “hearting”, filtering, etc. Inferred preferences may be determined based on a user's behavior with respect to content, such as search queries submitted by the user, ad clicks or watches, viewing for a threshold period of time, or other user interaction with the content. According to some examples, the content may include, be associated with, or identified by embeddings. The embeddings may be a representation of the brand, topics, products, etc. of the content. The preferences of the users may, in some examples, be identified using embeddings. The embeddings may be a numerical, alpha, or alpha-numerical representation of the subject of the content and/or the preferences of the user expressed as a vector. The declared and inferred preferences may be merged into a merged preference profile.

According to some examples, when merging the declared and inferred preferences, there may be a conflict between the declared and inferred preferences of a user. For example, a user may declare they do not want to see any digital components related to sports, but the user's inferred preferences may indicate they have searched for sporting goods stores. When merging the declared preferences and inferred preferences, conflicts, such as the one described, may be resolved by choosing the declared preference over the inferred preference.

The merged preference profile may be used for targeting and retrieval of digital components to output to the user. For example, a publisher may submit a request for one or more digital components to output to the user. When determining which digital components to be selected, at least a portion of the selected digital components are reserved for digital components related to the merged preference profile of the user.

To determine whether the digital components being considered match the user's preferences, the brands, topics, products, etc. (collectively referred to herein as the “subject”) of the digital components being considered may be compared to the user's merged preference profile. The subject of the digital components may be determined based on the content of the digital component, classifiers associated with the entities paying for the digital component, description of the digital component, landing page of the digital component, etc. According to some examples, the subject of the digital components may be determined based on embedding associated with the digital components. Once the subject of the digital component is determined, it may be compared to the subject(s) in the merged preference profile. At least one of the digital components having a threshold match with the subject of the merged preference profile may be a selected digital component and, therefore, output to the user. Additionally or alternatively, the embedding associated with the digital component may be compared to the embeddings associated with the merged preference profile. For example, a coordinate of the embedding of the digital component may be compared to the coordinates of the embeddings associated with the merged preference profile. A threshold match between the digital component and the merged preference profile may be a digital component having an embedding within a threshold of the coordinate of the embeddings associated with the merged preference profile.

According to some examples, the subject of the digital components may be used to ask survey questions to the user. The survey questions may be used to determine the declared preferences of the user, to reconcile conflicts between declared and inferred preferences, etc. For example, if the subject of the digital component is “basketball” and the user previously declared they are not interested in “sports,” the survey question may be “do you want to see more digital components related to basketball?” Based on the response, the declared preferences and, therefore, merged preference profile may be updated.

The reserved digital space for digital components related to the merged preference profile ensures that the user is presented with personalized digital components corresponding to their declared and inferred preferences. Moreover, by resolving conflicts between the user's declared and inferred preferences by selecting the declared preferences, digital components that are irrelevant are filtered out from the digital components being considered for selection. This may ensure that the user is presented with digital components that are relevant to their preferences and not what the digital component system may think is best for the user. For example, if the user has declared that they want to see fewer digital components related to electric vehicles (“EV”), the declared preference to see less EV digital components will override any inference they are to select EV digital components for output to the user.

Identifying digital components to be included during the selection process and reserving at least a portion of the selected digital components to be related to the positive preferences indicated in the merged preference profile may ensure that the digital components provided to the user are personalized to the interests and preferences of the user. By using the merged preference profile to select digital components, the computational efficiency of the process for selecting digital components is increased as compared to determining user preferences at the time a digital component is requested by a publisher. Moreover, by generating the merged preference profile prior to a publisher requesting digital components, the consistency and accuracy of the declarations is improved.

By providing digital components that will be accepted and used by the user, network bandwidth and other resources such as processor and memory overhead associated with transmitting the unwanted digital components to a publisher and/or user device are not wasted, because one or more replacement digital components do not need to be transmitted to the user subsequently to the digital component that was not wanted. Further, additional display space at the publisher and/or user device does not need to be reserved, also saving resources at the publisher/user device.

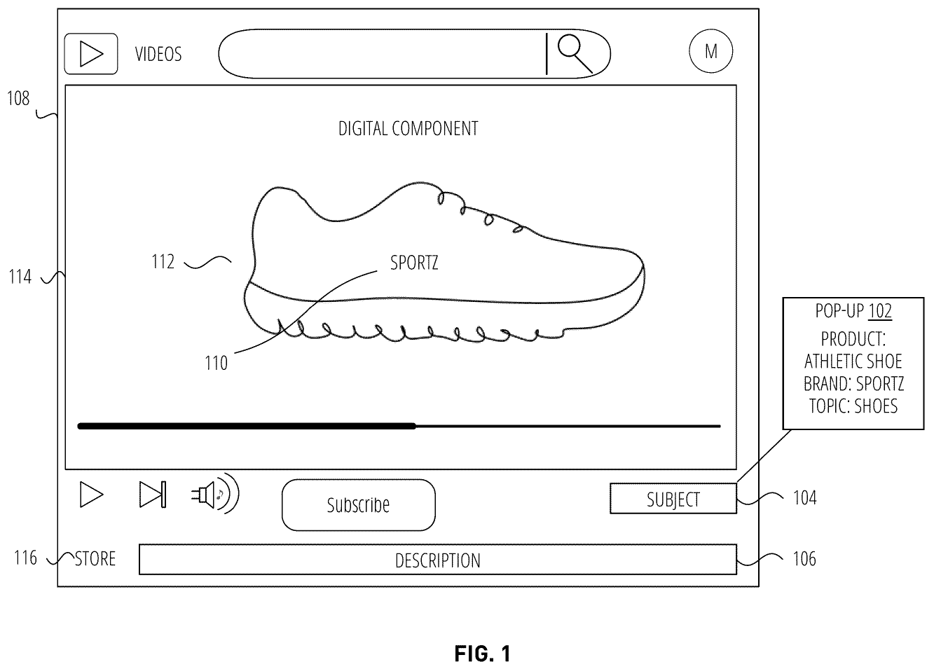

FIG. 1 is example content being output on a device. The subject, or focus, of the content 114 may be determined and used to determine user preferences. In some examples, an embedding associated with the subject of the content may be determined and used to determine user preferences. According to some examples, the content 114 may be used to identify digital components matching a merged preference profile of a user during the selection of digital components. The subject of the content 114 may include, for example, the brand, topic, type of product, etc. The subject may be associated with an embedding. The content 114 may include, for example, digital components, videos, images, information, etc.

According to some examples, the content 114 may be a video ad for a retail store selling shoes. The subject of the content 114 may be determined based on the brands 110, topics, products 106, etc. in the ad, such as the retail store, the type of shoes, the brand 110 of shoes, etc. The determined subject may be used to survey a user regarding the retail store 116, the type of shoes, or the brand 110 of shoes. In some examples, the determined subject may be used to determine inferred preferences of the user based on their engagement or behaviors with the content.

According to some examples, the subject of the content 114 may be determined based on the description 106, landing page, classifications associated with the content 114, etc. Continuing with the example above, the video for the retail store selling shoes may include a description of the type or brand 110 of shoes, information related to a sale, etc. In some examples, clicking on the video may lead to the landing page for the associated webpage of the retail store or the webpage for the brand of shoes in the video. Additionally, or alternatively, they may be classifications associated with the content 114, such as labels related to the subject of the content 114. Continuing the example provided, the classifications may be “shoes”, the specific brand 110, the specific type of shoe, etc.

In some examples, the subject of the content 114 may be provided for output alongside the content 114. For example, an indicator may be included such that, when selected, a pop-up 102 identifying the subject 104 of the content 114 may be output. This may provide clarity to users regarding the subject 104 of the content 114 as compared to the publisher providing the content 114. According to some examples, the subject 104 of the content 114 may identify the brand 110, topic, product 112 being promoted by the content 114 as compared to paying entity. Continuing with the video of the retail store 116 selling shoes, the brand 110 of shoe and type of shoe may be identified rather than identifying the retail store 116.

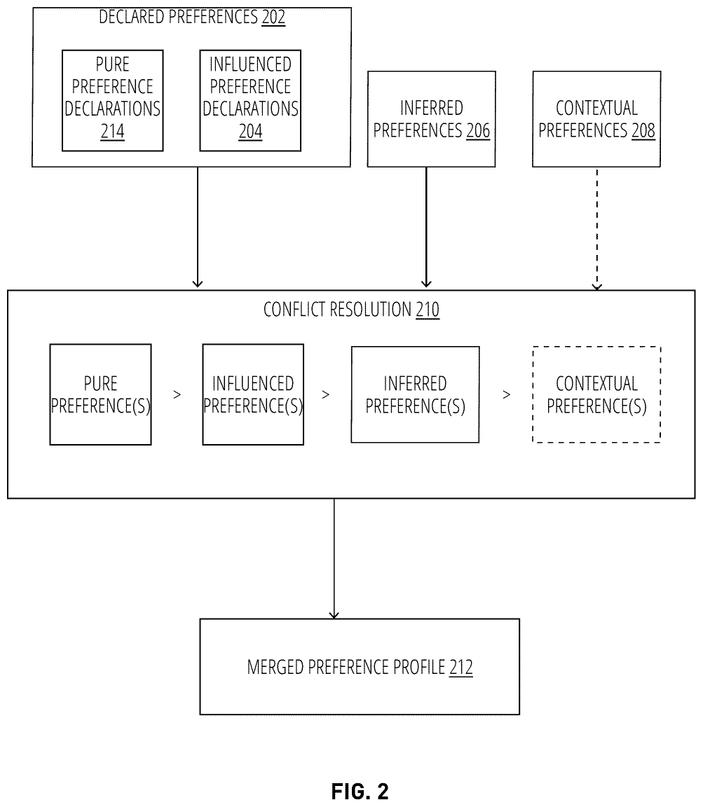

FIG. 2 is an example flow diagram for an example method of generating a merged preference profile 212. The merged preference profile 212 may be generated based on declared preferences 202, inferred preferences 206, and contextual preferences 208. Declared preferences 202, inferred preferences 206, and/or contextual preferences 208 may be determined based on a user's engagement, interaction, viewing, behaviors etc. relative to content. Accordingly, the declared preferences 202, inferred preferences 206, and/or contextual preferences 208 may change, be updated, confirmed, etc. based on the user's engagement, interaction, searching, selecting, viewing, etc.

As declared preferences 202 and inferred preferences 206 are determined, a conflict may arise between the declared preferences 202 and inferred preferences 206. The conflict may be resolved via conflict resolution 210. Conflict resolution 210 may utilize a hierarchy, weighted system, sliding sale, direct comparison, etc. to resolve the conflict between preferences. For example, a conflict may arise if a declared preference 202 is positive for sports but an inferred preference 206 is negative for hockey. Hockey is a sport and, therefore, there is a conflict between the positive declared preference 202 for sports and the negative inferred preference 206 for hockey. To resolve the conflict, conflict resolution 210 may give more weight to the declared preference 202 as compared to the inferred preference 206. In some examples, the conflict resolution 210 may consider other declared 202 and inferred 206 preferences when resolving the conflict. In some examples, conflict resolution 210 may resolve conflicts between contextual preferences 208 and declared 202 and/or inferred 206 preferences. Similar to resolving conflicts between declared 202 and inferred 206 preferences, conflict resolution 210 may resolve conflicts including contextual preferences 208 using a hierarchy, weights, a totality of the preferences, etc. Once any conflicts are resolved, the merged preference profile 212 may be generated.

Declared preferences 202 may include pure preference declarations 214 and influenced preference declarations 204. Pure preference declarations 214 may be preferences determined based on explicit user indications pertaining to topics, brands, interests, etc. The topics, brands, interest, etc. may correspond to the subject of the content. Influenced preference declarations 204 may be declarations that are based on a user's light engagement with the subject of the content. The content may include, for example, published web pages, ads, videos, images, etc. According to some examples, the declared preferences 202 may be determined based on content, digital components, ads, etc. previously provided for output. The declared preferences 202, inferred preferences 206, and contextual preferences 208 may be associated with embeddings. For example, user interaction with content may be associated with an embedding which is then included as a pure preference declaration 214 and/or influenced preference declaration 204, depending on the type of interaction. The embeddings, while not a human understandable taxonomy, may be used to identify similar content and/or based on the embeddings. According to some examples, the embeddings may be used to identify similar subjects, personalized content, personalized digital components, etc. that have embeddings within a threshold coordinate distance of the given embedding.

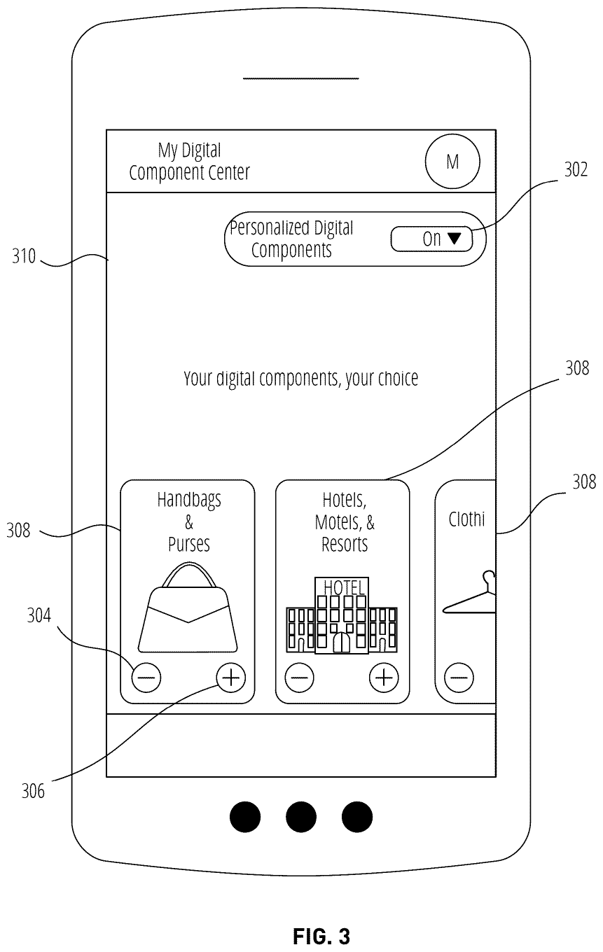

FIG. 3 illustrates an example user interface 310. The user interface 310 may include an input 302 allowing for the user to switch between receiving personalized ads based on the merged preference profile 212, receiving ads based on only contextual preferences 208, or not receiving personalized ads at all. While the input 302 for a user to choose to receive personalized ads is shown as a drop-down menu allowing a user to select “on” or “off,” the input 302 may be radio buttons, a sliding scale, check boxes, etc. Accordingly, the input 302 of user interface 310, as shown, is one example and is not intended to be limiting.

Pure preference declarations 214 may be determined based on inputs received via user interface 310. The inputs received from a user may indicate a preference for a given ad subject 308. The preference may be to increase or decrease the frequency of ads related to that subject 308. In some examples, the preference may be to increase 306 or decrease 304 the likelihood that a user is shown ads related to that subject 308. As shown, the ad subjects 308 may be “handbags and purses”, “hotels, motels, and resorts,” “clothing,” etc.

The inputs received via user interface 310 may provide an indication to increase 306 or decrease 304 the frequency of ads related to “handbags and purses,” “hotels, motels, and resorts,” and “clothing.” In such an example, the pure preference declarations 214 may be to increase 306 or decrease 304 the frequency and/or likelihood of showing ads related to “handbags and purses,” “hotels, motels, and resorts,” and “clothing.” While the inputs for increasing and decreasing the frequency or likelihood of showing ads of a specific subject 308 are shown as “plus” and “minus” buttons, the inputs may be a sliding scale, radio buttons, text box, etc. Accordingly, the user interface 310 is just one example for receiving pure preference declarations 214 and is not intended to be limiting.

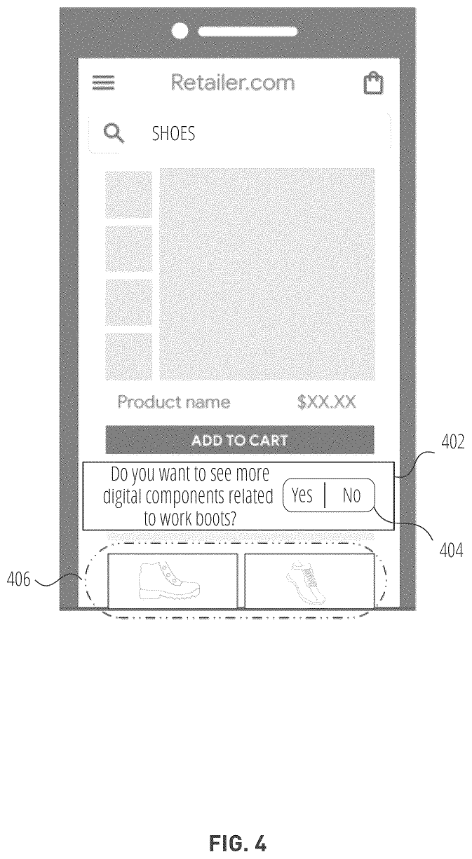

FIG. 4 illustrates another example for determining pure preference declarations 214. For example, instead of receiving inputs via user interface 310, inputs 404 may be received in the form of responses to survey question 402. The survey questions 402 may be related to the subject of the digital component 406. For example, the digital component 406 may be for shoes, such as work boots and dress shoes. In conjunction with the digital component 406, a survey question 402 may be provided confirming the user's interest in ads related to work boots. If an input 404 corresponding to the selection of “yes” is received, it may be determined that the pure preference declaration 214 is a positive declaration for ads related to work boots. If an input 404 corresponding to the selection of “no” is received, it may be determined that the pure preference declaration 214 is a negative declaration for ads related to work boots. According to some examples, a positive declaration may correspond to an increase in the frequency and/or likelihood of ads related to the given subject, e.g., work boots, while a negative declaration may correspond to a decrease in the frequency and/or likelihood of ads related to the given subject.

Influenced preference declarations 204 may be determined based on a user's light engagement with content, such as social media content, web page content, ads, etc. Light engagements may include a user reaction to the content. A reaction may include “liking” the content, a “heart” or any other emoji reaction, such as a thumbs-up, smiley face, angry face, etc. For example, if a user reacts to a social media post related to insulated travel mugs by “liking” the post, the influenced preference declarations 204 may be a positive declaration for insulated travel mugs. In some examples, if a user reacts to web page content related to disposable travel cups with an angry face emoji, the influenced preference declarations 204 may be determined to be a negative declaration for disposable travel cups. Positive declarations, or preferences, may correspond to brands, topics, products, etc. that a user is interested in seeing more of while negative declarations or preferences may correspond to brands, topics, products, etc. that a user is interested in seeing less, or none, of. According to some examples, the influenced preference declarations 204 may be determined based on the user's engagement, such as light engagements, with content, ads, digital components, etc. previously provided for output to the user.

Light engagements may be determined and used after the user provides authorization for the system to access or receive information related to the user's light engagements with content. According to some examples, authorization is provided via user engagement with the content. Any use of the user's light engagements is authorized by the user. For example, the user may provide authorization to an application for generating a merged preference profile by setting certain permissions for the application. The authorization may be for the application or system to access one or more databases or sub databases in the memory of the device. According to one example, the user may select specific sub-databases to which the application is granted access. For instance, the user may grant access to the search history database but not the video or content watches database.

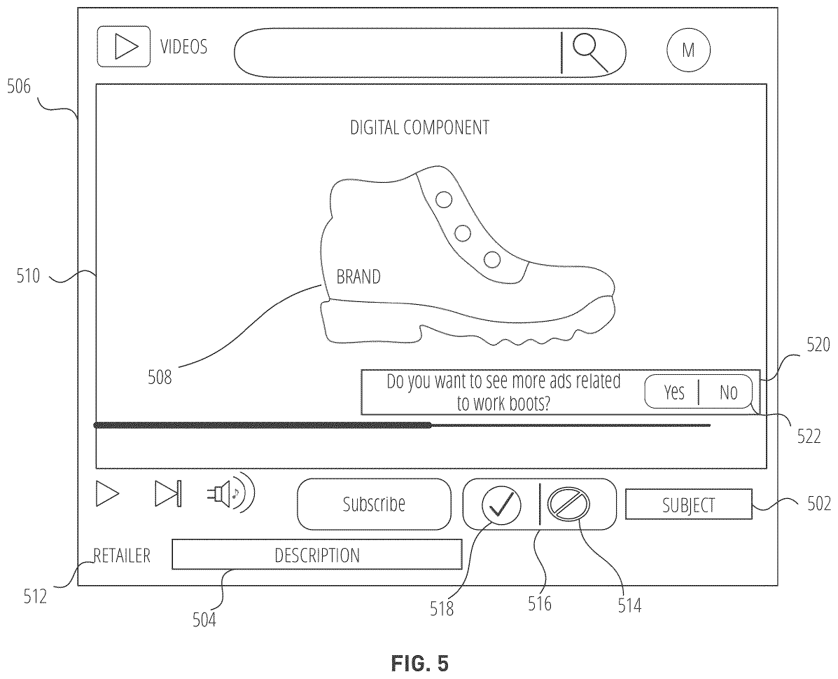

FIG. 5 illustrates an example output 506. The output 506 may include content 510, survey question 520, and reactions 516. The output 506 additionally includes information regarding the retailer 512, a description 504 of the content 510, an indication of the subject 502 of the content 510, and inputs 522 for responding to the survey question 520.

As shown, the content 510 includes an ad for work boots. The work boots are of a given brand 508 and the content 510 is being provided by retailer 512. The content 510 may be a video, a video still, an image, a gif, or any form of media.

Reactions 516 may provide inputs, such as positive 518 and negative 514, for reacting to or engaging with content 510. The reactions 516 may include positive 518 or negative 514 indications related to the brand 508, product, retailer 512, etc. As shown, a positive 518 reaction 516 may be determined when an input corresponding to a selection of the “check mark” is received. A negative 514 light engagement 516 may be determined when an input corresponding to the selection of the “cancel” symbol is received. While a “check mark” is shown as corresponding to a positive 518 reactions 516 and a “cancel” symbol is shown as corresponding to a negative 514 reactions 516, the reactions 516 may be any symbols, words, inputs, etc. Accordingly, positive 518 and negative 514 are just some examples and are not intended to be limiting.

According to some examples, the reactions 516 may be associated with an embedding. For example, instead of acknowledging a positive 518 reaction to the brand, product, retailer, etc., an embedding with a coordinate at or near the brand, product, retailer may be identified in response to receiving an input corresponding to the selection of the positive 518 reaction. In some examples, instead of acknowledging a negative reaction 514, an embedding with a coordinate opposite the brand, product, retailer, etc. may be identified as something the user may be interested in. Additionally or alternatively, in response to a negative reaction 514, an embedding with a coordinate corresponding to the brand, product, retailer, etc. may be identified. Embeddings associated with negative reactions may be used to ensure that digital components with subjects having embeddings near the negative reaction embedding are not provided to the user.

Influenced preference declarations 204 may be determined based on inputs corresponding to the selection of positive 518 or negative 514. The reaction 516, or selection of positive 518 or negative 514, may be received relative to the content 510, brand 508, retailer 512, subject 502, etc. While reaction 516 is shown relative to content 510, additional reactions 516, e.g., positives 518 and negative 514, may be provided relative to the brand 508, retailer 512, subject 502, etc.

Inferred preferences 206 may be determined based on a user's interaction with the content. User interactions may include, for example, search queries for a subject, e.g., brand, topic, product, etc., clicks, watches, etc. Clicks may correspond to a selection of content and watches may correspond to the viewing of a video, video clip, gif, etc. According to some examples, if the system receives a search query for left-handed scissors, receives input corresponding to a selection of an ad for left-handed scissors, and/or determines that content for left-handed scissors has been viewed, the system may infer a positive preference for left-handed scissors.

Influenced preference declarations 204 and/or inferred preferences 206 may be associated with embeddings. For example, rather than identify the subject of the influenced preference declaration 204 and/or inferred preference 206, an embedding may be identified. The embedding may map the influenced preference declarations 204 and/or inferred preferences 206 to a coordinate such that digital components having an embedding nearby, or within a threshold, may be selected and provided for output to the user. The embeddings may, therefore, allow the system to identify digital components that are similar to the embeddings of the user preferences. This may allow the system to personalize the digital components provided to the user.

According to some examples, the inferred preferences 206 may be determined based on the user's engagement or behavior with respect to content, ads, digital components, etc. previously provided for output to the user. Inferred preferences may be determined and used after the user provides authorization for the system to access or receive information related to the user's interaction with content. Any use of the user's interaction is authorized by the user.

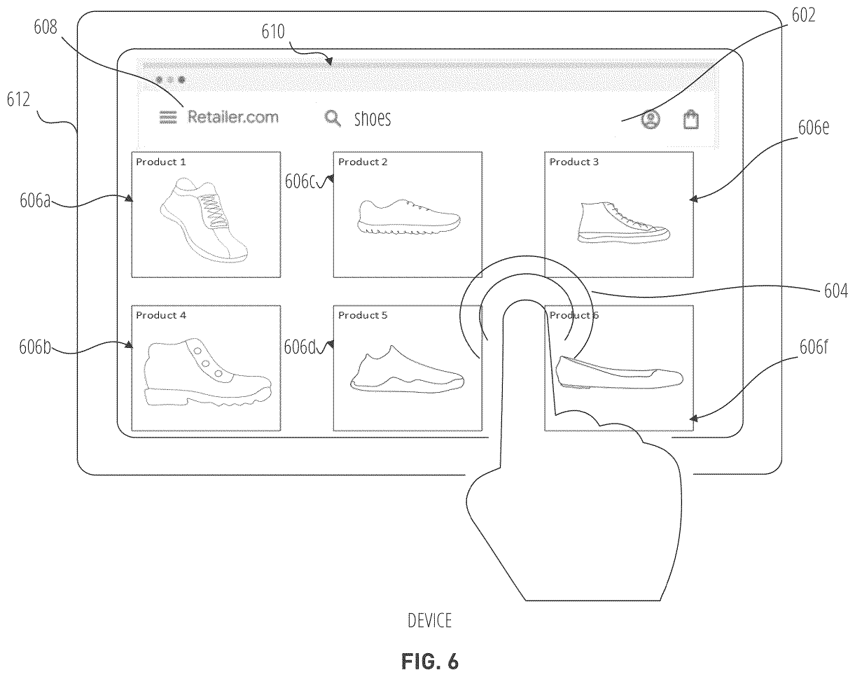

FIG. 6 illustrates an example output of search results in response to a search query. For example, a publisher 608 may receive a search query 602 for “shoes.” In response to the search query 602, the publisher 608 may provide content 610 for output on a display of a user device 612. The content 610 may include one or more search results 606a, 606b, 606c, 606d, 606e, 606f. The search results may be products, such as products 1-6. The search results may be relevant to the search query 602. For example, as the search query 602 was for shoes, products 1-6 may be different types of shoes.

Inferred preferences 206 may be determined based on the search query 602. For example, the inferred preference 206 may be determined to be shoes. Additionally, or alternatively, inferred preferences 206 may be determined based on clicks. For example, if an input 604 corresponding to the selection of a given product 1-6 is received, the inferred preference 206 may be determined based on the input 604, e.g., the selected product.

While the content 610 is shown as search results for a retailer, the content 610 may be any content, such as videos, news articles, advertisements, etc. Accordingly, inferred preferences 206 may be determined based on clicks, watches, hovering, selections, etc. of any type of content.

According to some examples, contextual preferences 208 may be determined based on the content 610 being viewed and/or the context of the content 610, without any user history. Contextual preferences 208 may be determined based on the content 610 currently being output to a user whereas inferred preferences 206 may be determined based on current and/or historical content 610 output to the user. Referring to FIG. 6, the search query 602 was for shoes such that the contextual preferences 208, in addition to the inferred preferences 206, may be determined to be shoes. If no other information regarding the user's merged preference profile 212 was available, digital components may be provided related to the search query 602, e.g., shoes. In examples where the user's merged preference profile 212 is available, the digital components provided for output may be related to the search query 602 as well as the user's declared preferences 202 and inferred preferences 206.

Contextual preferences may be determined and used after the user provides authorization for the system to access or receive information related to the user's interaction with content and/or viewing of the content. Any use of the user's interaction is authorized by the user.

According to some examples, there may be a conflict between the declared preferences and the inferred preferences. To resolve the conflict between declared, inferred, and contextual preferences, the system may use a hierarchy. For example, pure preference declarations may be given the most weight when resolving a conflict as compared to a contextual preference. According to some examples, the hierarchy, from greatest weight to least amount of weight, may be, pure preference declarations, influenced preference declarations, inferred preferences, and contextual preferences. The conflict will be resolved by selecting the subject, e.g., topic, brand, product, etc., from the preference with the greatest weight. While the preferences are provided as a hierarchy from pure declarations to contextual preferences, the hierarchy described is just one example as the hierarchy may be provided in any order, giving the greatest weight to any of the preferences.

According to some examples, the freshness of the declared, inferred, and contextual preferences may be used to resolve a conflict between the declared, inferred, and contextual preferences. The freshness of the preferences may be, for example, a timing of the preference, an amount of the freshness, etc. For example, when resolving conflicts, the system may determine whether a declared negative preference for a topic was received after the user was engaging with the topic for an extended period of time. In another example, when resolving conflicts, the system may determine that the preference for a topic was received a period of time before recent engagement with the same topic. The freshness, such as the timing of the received preferences, the timing of the engagement with the topic as compared to the received preference, etc. may, therefore, be used when resolving conflicts.

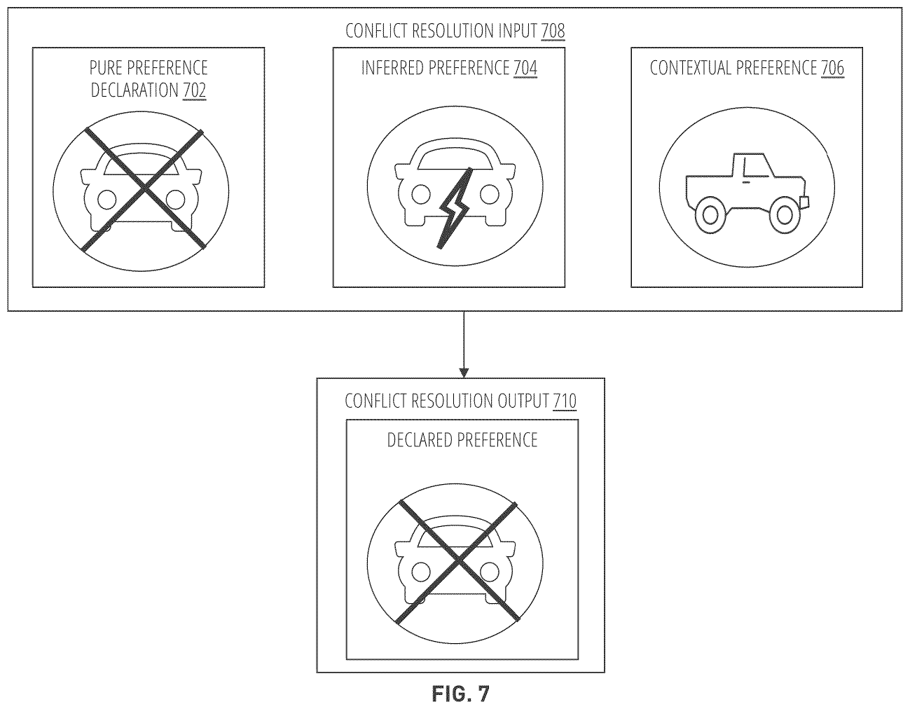

FIG. 7 illustrates an example of resolving conflicts between declared preferences, inferred preferences, and contextual preferences. For example, the pure preference declaration 702 may be negative for content related to cars, the inferred preference 704 may be positive for content related to electric vehicles, and the contextual preference 706 may be content related to pick-up trucks. In such an example, there is a conflict between the declared preference and the inferred and contextual preferences. That is, the pure preference declaration 702 indicating a negative declaration for content related to cars contradicts the inferred preference 707 for electric vehicles and the contextual preference 706 for pick-up trucks.

To resolve conflicts, such as the one described above, conflict resolution 210 may determine the preference, e.g., pure preference declaration 702, with the greatest weight in the hierarchy. In this example, the preference with the greatest weight in the hierarchy may be pure preference declarations 214. As the declared preference is a negative for content related to cars, the conflict may be resolved by following the declared preference and ignoring the inferred and contextual preferences. Continuing with the example, the conflict may be resolved by indicating a negative preference for content related to cars and ignoring the positive preference for electric vehicles and pick-up trucks.

In some examples, conflict resolution may be determined based on responses to survey questions and/or natural language inputs. Continuing with the example related to cars, if the declared preference is negative for content related to cars but the inferred preference is positive for content related to electric vehicles, the system may transmit a survey question related to the user's declarations. For example, the survey question may be “Do you want to change your declared preferences?” or “Do you want to see content related to cars?” The input received in response to the survey questions may be used to update the declared preferences and, therefore, be used to resolve conflicts between the user's preferences. According to some examples, the natural language inputs may be automated chats providing survey questions asking users to declare their preferences.

According to some examples, a conflict may be resolved by inferring a new preference based on the combination of data. For example, a preference for EV pick-up trucks may be inferred based on the combination of the inferred preference 704 for electric vehicles and the contextual preference 706 for pick-up trucks. In some examples, a preference for vehicles other than a sedan with a combustion engine may be inferred based on the inferred preference 704 for electric vehicles and the contextual preference 706 for pick-up trucks.

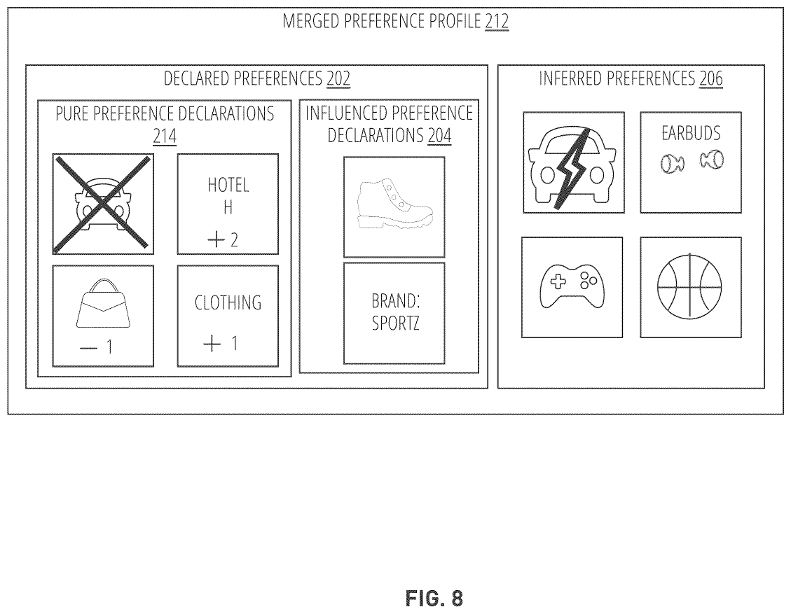

FIG. 8 is an example merged preference profile 212. As discussed above and herein, the merged preference profile 212 may be determined based on the declared preferences 202 and inferred preferences 206. According to some examples, the merged preference profile may be the preferences of the user after resolving conflicts between the declared, inferred, and contextual preferences of the user. The resulting merged preference profile may be used for targeting retrieval of digital components, such as ads, to be output to the user.

The declared preferences 202 include pure preference declarations 214 and influenced preference declarations 204. The pure preference declarations 214 may be determined based on a user's explicit declarations on the subject of content. As discussed with respect to FIGS. 3 and 4, explicit declarations may be determined based on inputs indicating a preference for a given subject or inputs in response to survey questions. As shown, the pure preference declarations 214 include an indication to not display any digital components, or advertisements, related to cars. The pure preference declarations 214 may, additionally or alternatively, include an indication to reduce the number of digital components related to “handbags and purses,” while including an indication to increase the number of digital components related to “Hotel H” and “clothing.” According to some examples, the greater the value of the positive indication the greater the frequency display components related to that subject should be shown. In some examples, the greater the value of the negative indication, the lower the frequency display components related to that subject should be shown. While the indications to increase or decrease the frequency are shown as positive and negative values, the indications may be provided as a sliding scale, check boxes such as “yes” or “no” or “display” or “do no display,” radio buttons, etc. Further, in some examples, the indications may or may not be provided for output. Accordingly, the indications as shown are just one example and are not intended to be limiting.

The influenced preference declarations 204 may be determined based on a user's light engagement with the content. As discussed with respect to FIG. 5, light engagements with content may include a user reaction to the content, such as “liking,” “hearting,” “angry,” etc. As shown in FIG. 8, the influenced preference declarations 204 include work boots and the brand “Sportz.” According to some examples, the influenced preference declarations may include an indication to increase or decrease the frequency of providing digital components related to a given subject. The indications may be, for example, a positive or negative value, such as those shown in the pure preference declarations 214, a sliding scale, check boxes, radio buttons, etc.

The inferred preferences 206 may be determined based on the user's interaction with or behavior with respect to the content. As discussed with respect to FIG. 6, user interaction may include, for example, search queries, clicks corresponding to a selection of content, watches corresponding to the viewing of content, page dwell time, long clicks versus short clicks, long watch versus short watch, etc. Long clicks may refer to, for example, user interaction with search results in response to a search queries whereas short clicks may, for example, indicate that there was little to no user interaction with the search results. In some examples, short clicks may indicate that the search results did not include content the user was interested in. Long watches may refer to, for example, user watch time for given content, such as a video. Short watches, in comparison, may indicate that the user spent little to no time watching the content.

As shown in FIG. 8, the inferred preferences 206 may include electric vehicles, earbuds, video games, and basketball. According to some examples, the inferred preferences 206 may include an indication to increase or decrease the frequency of providing digital components related to the given subject. In some examples, survey questions may be output to the user asking whether the inferred preferences 206 should be pure preference declarations 214.

According to some examples, the merged preference profile may be generated offline in the user personalization system (“UPS”) as opposed to generating the merged preference profile when determining what ads to include in an auction. For example, generating the merged preference profile offline may include generating the merged preference profile based on the past history and/or activity of the user and not at the time an ad server receives a request for an ad. The UPS may generate personalization information for users to be included in the merged preference profile. According to some examples, the UPS may be run offline and/or when new activity is detected for a user. The UPS may update the merged preference profile based on the generated personalization information.

When an ad server receives a request from a publisher for an ad to fill display space, the ad server may identify the user viewing the publisher's website or mobile application. The ad server may receive the user's merged preference profile. For example, at the time of the ad request, the ad server may have full context regarding the request, such as who, where, when, what, etc. According to some examples, the who may be the user, the where may be the publisher's website or application, the when may be the day of the week, the time of the day, etc., the what may be the action of the user. For example, the what may be included as an ad request when the user is watching a video, after watching a sequence of videos, after searching for reviews about a certain topic, etc. According to some examples, the ad server may, additionally or alternatively, identify the context of the request for an ad. The context may include the who, what, where, when, etc., such as the time of day, what day it is, what content the user is viewing, etc. The ad server may use the merged preference profile and/or the content to identify relevant ads to be included in an auction. In some examples, the merged preference profile that was generated offline may improve the efficiency of the ad server when responding to the ad request. For example, the ad server may use the merged preference profile that was generated offline, including user declarations, to identify relevant ads in view of the context of the request.

Generating the merged preference profile prior to auction may ensure consistency of the declared preferences across all applications. According to some examples, generating the merged preference profile on the build-side and materializing the merged preference profile on the server side may allow for multiple ad serving stacks to read one source. Reading one source, such as the merged preference profile, may allow the system to apply the preferences in the merged preference profile consistently.

The multiple separate ad serving stacks may operate based on shared data. The shared data may be, for example, personalization data. According to some examples, the merged preference profile may be used to train machine learning models across users. For example, the merged preference profiles of a plurality of users may be used to train machine learning models to predict interests, or preferences, of other users based on the preferences of users with similar interest. In another example, the merged preference profiles bay be used as the ground truth for models trying to predict interests for other users. In yet another example, the merged preference profiles may be used as input into a recommendation model. The recommendation model may be, for example, a model to recommend content. The recommendation of content may be, for example, in response to search queries.

The merged preference profile 212 may be used to target and retrieve ads to be included in the selection process. For example, advertisers, as part of the selection process, may bid to have their ads displayed on a publisher's website or mobile application. The ads included in the selection may be based, at least in part, on the merged preference profile 212 of the user. According to some examples, ads with a subject related to negative preferences may be filtered out such that they are limited in number or not included in the selection process. At least a portion of the selected ads may be reserved for ads having a subject related to the positive preferences in the merged preference profile 212 of the user.

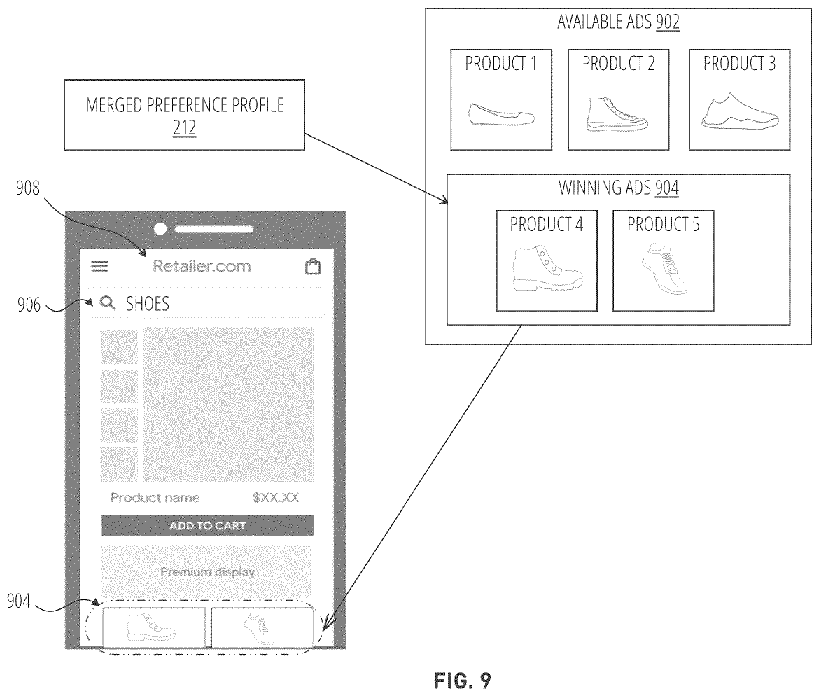

FIG. 9 illustrates an example flow diagram of the selection process. A publisher 908, such as “retailer.com,” may receive a search query 906 for “shoes.” In response to receiving the search query 906, the publisher 908 may transmit a request to an ad server for one or more ads to be presented to the user in addition to the search results. The request may be based on the search query for “shoes.” For example, the request may include a request for ads corresponding to or associated with “shoes.”

The ad server may receive the request, including the terms of the search query, e.g., “shoes,” and identify one or more available ads 902 related to the request from the publisher and/or the terms of the search query. As shown in FIG. 9, the available ads 902 may include ads for products 1-5.

When selecting one or more of the available ads 902 to return in response to the request from the publisher 908, the ad server may select ads related to the preferences in the merged preference profile 212. For example, the ad server may compare the brands, topics, products, etc. identified as having positive or negative preferences with the brands, topics, products, etc. of the ads. According to some examples, if the merged preference profile 212 includes a positive preference for an athletic brand and the ad subject is sports, the system may determine the ad is a match to the merged preference profile. In another example, if the merged preference profile 212 includes a negative preference for a clothing brand and the ad subject is apparel, the system may determine the ad is not a match to the merged preference profile 212. In examples where the ad server determines the ad is a match to the merged preference profile 212, the ad may be included in the selection process. In examples where the system determines the ad is not a match to the merged preference profile 212, the ad may be excluded from the selection process. This may ensure that the ads provided for output to the user substantially correspond to the preferences indicated in the merged preference profile 212.

As shown in FIG. 9, the one or more available ads 902 may be identified. The available ads 902 may be for products 1-6. According to some examples, products 1-6 may be related or relevant to the request from the publisher. The ad server may compare the available ads 902 with the preferences of the merged preference profile 212. For example, the merged preference profile 212 may indicate that there is a positive preference for work boots, the ad server may ensure that the ad for product 4 is included in the selection process. The winning, or selected, ads 904 may be provided for output, by the publisher 908, alongside the search results.

In some examples, a machine learning (“ML”) model may be used to identify ads to be included in the selection process. The ML model may be trained to determine whether the subject of the ad matches the preferences indicated in the merged preference profile 212. Each training example may consist of an ad. The input features to the ML model may be the subject of the ad, such as the topic, brand, product, etc., the positive preferences indicated in the merged preference profile 212, and the negative preferences indicated in the merged preference profile 212. According to some examples, the input features to the ML model may, additionally or alternatively, be the embeddings associated with the ad and the preferences indicated in the merged preference profile. The ML model may use the input features to more accurately determine whether the subject of the ad matches the preferences in the merged preference profile 212. In some examples, the ML model may use the input features to more accurately determine whether the embeddings of the ad matches the embeddings in the merged preference profile. The output of the ML model may be a determination of whether the ad should be included in the selection process. In some examples, the system may ask for feedback from the user, such as by providing survey questions related to the brand, topic, good, etc. in the ad. For example, the user may be asked to confirm whether ads related to a given brand, topic, or good should be provided. The user may provide feedback, such as yes or no, indicating that the determination was correct.

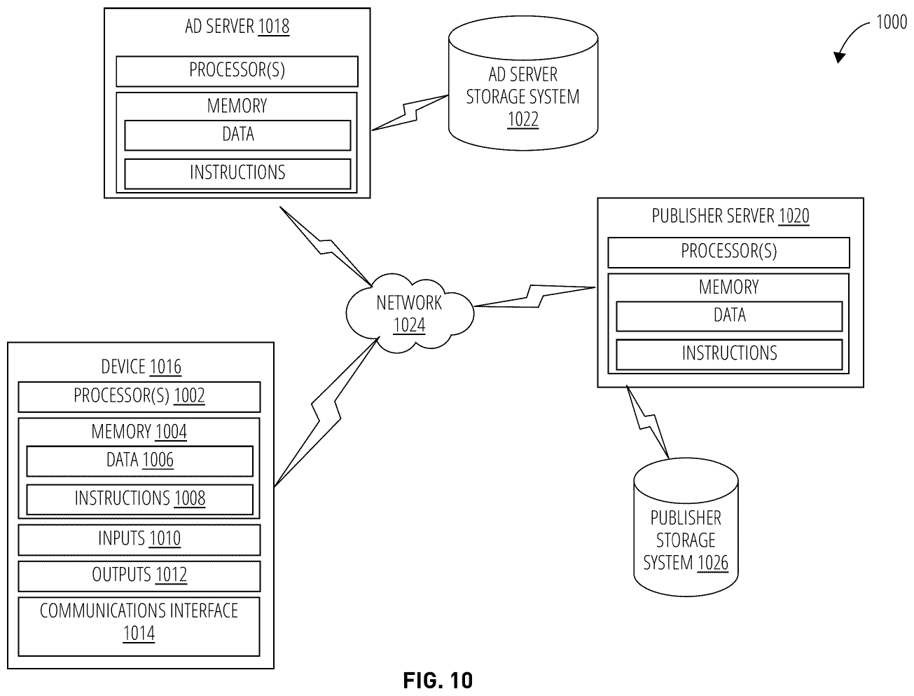

FIG. 10 illustrates an example system in which the features described above and herein may be implemented. It should not be considered as limiting the scope of the disclosure or usefulness of the features described herein. In this example, system 1000 includes Device 1016, ad server 1018, ad server storage system 1022, publisher server 1020, publisher storage system 1026, and network 1024.

Device 1016 may include one or more processors 1002, memory 1004, data 1006 and instructions 1008. Device 1016 may also include inputs 1010, outputs 1012, and a communications interface 1014. The device may be, for example, a smart phone, tablet, laptop, smart watch, AR/VR headset, smart helmet, home assistant, etc.

Memory 1004 of device may store information that is accessible by processor 1002. Memory 1004 may also include data that can be retrieved, manipulated or stored by the processor 1002. The memory 1004 may be of any type capable of storing information accessible by the processor 1002, including a computer-readable medium which may be non-transitory, or other medium that stores data that may be read with the aid of an electronic device, such as a hard-drive, memory card, read-only memory (“ROM”), random access memory (“RAM”), optical disks, as well as other write-capable and read-only memories. Memory 1004 may store information that is accessible by the processors, including instructions that may be executed by processors 1002, and data 1006.

Data 1006 may be retrieved, stored or modified by processors 1002 in accordance with instructions 1008. For instance, although the present disclosure is not limited by a particular data structure, the data may be stored in computer registers, in a relational database as a table having a plurality of different fields and records, XML documents, or flat files. The data may also be formatted in a computer-readable format such as, but not limited to, binary values, ASCII or Unicode. By further way of example only, the data 1006 may comprise information sufficient to identify the relevant information, such as numbers, descriptive text, proprietary codes, pointers, references to data stored in other memories (including other network locations) or information that is used by a function to calculate the relevant data.

The instructions 1008 can be any set of instructions to be executed directly, such as machine code, or indirectly, such as scripts, by the processor. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 1002 may include any conventional processors, such as a commercially available CPU or microprocessor. Alternatively, the processor 1002 can be a dedicated component such as an ASIC or other hardware-based processor. Although not necessary, device 1016 may include specialized hardware components to perform specific computing functions faster or more efficiently.

Although FIG. 10 functionally illustrates the processor 1002, memory 1004, and other elements of device 1016 as being within the same respective blocks, it will be understood by those of ordinary skill in the art that the processor 1002 or memory 1004 may actually include multiple processors or memories that may or may not be stored within the same physical housing. Similarly, the memory 1004 may be a hard drive or other storage media located in a housing different from that of device 1016. Accordingly, references to a processor or device will be understood to include references to a collection of processors or devices or memories that may or may not operate in parallel.

The inputs 1010 may be, for example, a mouse, keyboard, touchscreen, microphone, or any other type of input. The inputs may receive keywords for a search on a publisher's website or mobile application. According to some examples, the inputs 1010 may receive indications regarding positive and negative declarations for a given subject. Additionally, or alternatively, the inputs 1010 may receive light engagements with content. In some examples, inputs 1010 may receive user interaction with content, such as clicks.

Output 1012 may be a display, such as a monitor having a screen, a touchscreen, a projector, or a television. The display 1012 of the device may electronically display information to a user via a graphical user interface (“GUI”) or other types of user interfaces. For example, display may electronically display product information, digital components, and ads, etc. on a publisher's website or mobile application.

Although only one device is depicted in FIG. 10, it should be appreciated that a typical system can include one or more computing devices 1016, with each computing device being at a different node of the network. The devices may be capable of directly and indirectly communicating with other nodes of the network. The network and intervening nodes described herein can be interconnected using various protocols and systems, such that the network can be part of the Internet, World Wide Web, specific intranets, wide area networks, or local networks. The network can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 1000 may include one or more server computing devices, such as ad server 1018 and publisher server 1020. The server computing devices may be, for example, a load balanced server farm, that exchange information with different nodes of a network for the purpose of receiving, processing and transmitting the data to and from other computing devices. For instance, ad server 1018 and publisher server 1020 may be a web server that is capable of communicating with the device via the network. In addition, ad server 1018 and publisher server 1020 may use the network to transmit and provide information to a user of device 1016. Ad server 1018 and publisher server 1020 may include one or more processors, memory, data, instructions, etc. These components operate in the same or similar fashion as those described above with respect to device 1016.

Ad server 1018 may manage digital components, such as ads, and provide various services to the advertisers, publishers, and devices. According to some examples, ad server 1018 may receive ad campaigns from one or more advertisers. The ad campaigns may include campaign information, such as the products, bidding strategy, targeting information, duration, etc. The ad campaigns may be stored in the memory of ad server 1018 and/or in ad server storage system 1022.

According to some examples, publisher server 1020 may receive a search query from device 1016. For example, the search query may be for specific content, such as product information. In response to the request, publisher server 1020 may retrieve relevant content from publisher storage system 1026. The publisher server 1020 may transmit a content page or other presentation, representation, or characterization of the content to the requesting device 1016. The content page may include, for example, digital components, such as ads.

According to some examples, in response to the received search query, publisher server 1020 may transmit a request to ad server 1018. The request may be for one or more digital components, such as ads. Ad server 1018 may facilitate the identification of relevant ads for distribution to the publishers. The relevant ads may be determined based on, at least in part, the merged preference profile of a user. For example, the ad server may identify available ads in response to the request from the publisher server. The ad server may identify which of the available ads matches the preferences in the merged preference profile. At least one of the ads selected to be returned to the publisher may correspond to the preferences in the merged preference profile.

Device 1016 may present in a viewer, such as a browser, mobile application, or other content display system, the search query results integrated with one or more of the ads provided by the ad server.

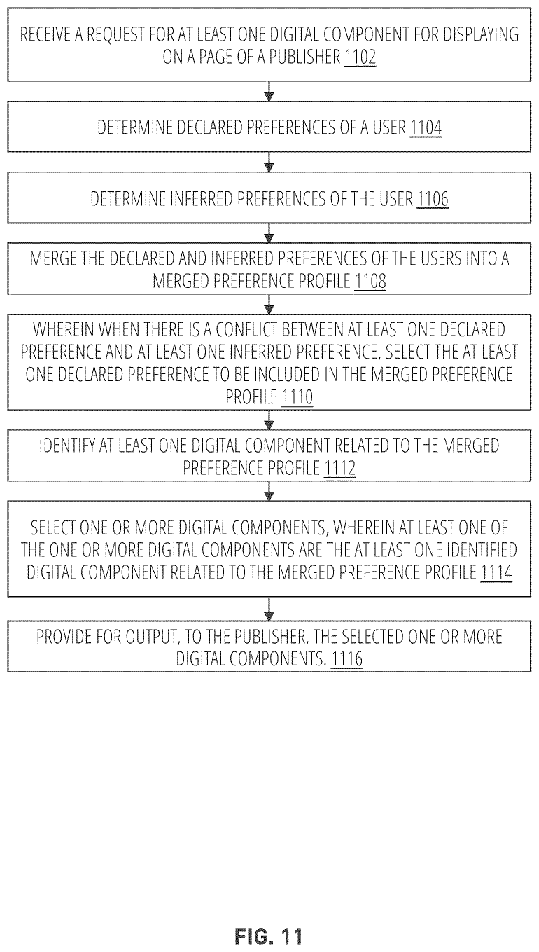

FIG. 11 illustrates an example method for providing at least one winning advertisement in response to a request from a publisher. The following operations do not have to be performed in the precise order described below. Rather, various operations can be handled in a different order or simultaneously, and operations may be omitted.

In block 1102, a request for at least one digital component for displaying on a page of a publisher may be received. The request may be received from the publisher. The digital component may be an ad, such that the request from the publisher is for one or more advertisements to be displayed.

In block 1104, declared preferences of a user may be determined. The declared preferences of the user may be related to at least one subject of digital components previously provided for output. The subject of the digital components may include, for example, a brand, a topic, or a product. In some examples, the declared preferences may be determined based on user input received in connection with the digital components previously provided for output.

According to some examples, the declared preferences may include at least one of pure preference declarations or influenced preference declarations. The pure preference declarations may be determined based on at least one of a user profile or input received in response to one or more survey questions. The influenced preference declarations may be determined based on user interaction with at least one of content or digital components previously provided for output.

In block 1106, inferred preferences of the user may be determined. Inferred preferences may be determined by identifying one or more engagements with a subject of content previously provided for output or one or more search queries for the subject of the content. The content may include digital components, such as ads, and the subject of the content includes at least one of a brand, a topic, or a product.

In block 1108, the declared and inferred preferences of the user may be merged into a merged preference profile. The merged preference profile may include declared preferences, such as pure preference declarations and/or influenced preference declarations, inferred preferences, and/or contextual preferences.

In block 1110, when there is a conflict between at least one declared preference and at least one inferred preference, the at least one declared preference may be selected to be included in the merged preference profile. According to some examples, the at least one inferred preference in conflict with the at least one declared preference may be discarded.

In block 1112, at least one digital component related to the merged preference profile may be identified. For example, in response to receiving the request for at least one digital component, a plurality of available digital components may be identified. Based on the plurality of available digital components, at least one digital component may be identified as related to the merged preference profile. For example, the at least one digital component identified as related to the merged preference profile may have a subject corresponding to an indicated preference in the merged preference profile.

In block 1114, one or more digital components may be selected. At least one of the one or more digital components is the at least one identified digital component related to the merged preference profile. According to some examples, display space for the selected one or more digital components related to the merged preference profile may be reserved.

In block 1116, the selected one or more digital components may be provided to the publisher for output. The publisher may output the digital components for display on their website, mobile application, etc. For example, the publisher may output the digital component alongside search results or other content, such as videos, articles, etc.

By providing digital components based on a user's merged preference profile, the digital components likely will be accepted and used by the user. Providing digital components that are accepted and used by the user may decrease the network bandwidth and other computer-based resources, such as processor and memory overhead associated. For example, by providing digital components that are accepted and used by the user, unwanted and/or replacement digital components do not need to be transmitted to the user to replace previously transmitted digital components that were not wanted. Further, display space for the publisher may be conserved as the publisher does not need to reserve additional display space for unwanted digital components.

Moreover, the digital components are likely to be accepted and used by the user in view of the preferences indicated in the merged preference profile of the user. Using the merged preference profile to select digital components that will be accepted and used by the user increases the computational efficiency for selecting digital components, as compared to determining user preferences at the time of the publisher's request. Moreover, selecting digital components based on the merged preference profile improves the accuracy and consistency of selecting digital components that will be accepted and used by the user.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors from a publisher, a request for at least one digital component for displaying on a page of a publisher;
determining, by the one or more processors, declared preferences of a user;
determining, by the one or more processors, inferred preferences of the user;
merging, by the one or more processors, the declared and inferred preferences of the users into a merged preference profile;
wherein when there is a conflict between at least one declared preference and at least one inferred preference, selecting, by the one or more processors, the at least one declared preference to be included in the merged preference profile;
identifying, by the one or more processors, at least one digital component related to the merged preference profile; and
selecting, by the one or more processors, one or more digital components, wherein at least one of the one or more digital components are the at least one identified digital component related to the merged preference profile; and
providing for output, by the one or more processors to the publisher, the selected one or more digital components.

2. The method of claim 1, further comprising discarding, by the one or more processors, the at least one inferred preference in conflict with the at least one declared preference.

3. The method of claim 1, further comprising reserving, by the one or more processors, display space for the selected one or more digital components related to the merged preference profile.

4. The method of claim 1, wherein the declared preferences of the user are related to at least one subject of digital components previously provided for output.

5. The method of claim 4, wherein the at least one subject of the digital components includes a brand, a topic, or a product.

6. The method of claim 4, wherein the declared preferences are determined based on user input received in connection with the digital components previously provided for output.

7. The method of claim 1, wherein the declared preferences include at least one of pure preference declarations or influenced preference declarations.

8. The method of claim 7, wherein:
the pure preference declarations are determined based on at least one of a user profile or input received in response to one or more survey questions, and
the influenced preference declarations are determined based on user interaction with at least one of content or digital components previously provided for output.

9. The method of claim 1, wherein the inferred preferences are determined by identifying one or more behaviors with respect to a subject of content previously provided for output or one or more search queries for the subject of the content.

10. The method of claim 9, wherein the content includes digital components and the subject of the content includes at least one of a brand, a topic, or a product.

11. A non-transitory computer-readable storage medium, the computer-readable storage medium including instructions that when executed by a one or more processors, cause the one or more processors to:
receive, from a publisher, a request for at least one digital component for displaying on a page of a publisher;
determine declared preferences of a user;
determine inferred preferences of the user;
merge the declared and inferred preferences of the users into a merged preference profile;
wherein when there is a conflict between at least one declared preference and at least one inferred preference, select, by the one or more processors, the at least one declared preference to be included in the merged preference profile;
identify at least one digital component related to the merged preference profile;
select one or more digital components, wherein at least one of the one or more digital components are the at least one identified digital component related to the merged preference profile; and
provide for output, to the publisher, the selected one or more digital components.

12. The non-transitory computer-readable storage medium of claim 11, wherein the instructions further configure the one or more processors to discard, by the one or more processors, the at least one inferred preference in conflict with the at least one declared preference.

13. The non-transitory computer-readable storage medium of claim 11, wherein the instructions further configure the one or more processors to reserve, by the one or more processors, display space for the selected one or more digital components related to the merged preference profile.

14. The non-transitory computer-readable storage medium of claim 11, wherein the declared preferences of the user are related to at least one subject of digital components previously provided for output.

15. The non-transitory computer-readable storage medium of claim 14, wherein the at least one subject of the digital components includes a brand, a topic, or a product.

16. The non-transitory computer-readable storage medium of claim 14, wherein the declared preferences are determined based on user input received in connection with the digital components previously provided for output.

17. The non-transitory computer-readable storage medium of claim 11, wherein the declared preferences include at least one of pure preference declarations or influenced preference declarations.

18. The non-transitory computer-readable storage medium of claim 17, wherein:
the pure preference declarations are determined based on at least one of a user profile or input received in response to one or more survey questions, and
the influenced preference declarations are determined based on user interaction with at least one of content or digital components previously provided for output.

19. The non-transitory computer-readable storage medium of claim 11, wherein the inferred preferences are determined by identifying one or more behaviors with respect to a subject of content previously provided for output or one or more search queries for the subject of the content.

20. (canceled)

21. A system comprising:
one or more processors, the one or more processors configured to:
receive, from a publisher, a request for at least one digital component for displaying on a page of a publisher;
determine, declared preferences of a user;
determine, inferred preferences of the user;
merge the declared and inferred preferences of the users into a merged preference profile;
wherein when there is a conflict between at least one declared preference and at least one inferred preference, select the at least one declared preference to be included in the merged preference profile;
identify, at least one digital component related to the merged preference profile;
select one or more digital components, wherein at least one of the one or more digital components are the at least one identified digital component related to the merged preference profile; and
provide for output, to the publisher, the selected one or more digital components.

22-30. (canceled)
